(19) United States
(12) Patent Application Publication
(10) Pub. No.: US 2004/0024640 A1
(43) Pub. Date: Feb. 5, 2004

(54) System and method for manipulating internet-based advertisements

(76) Inventors: Joseph Craig Engle, Carmel, IN (US); Jay William Lesandrini, Carmel, IN (US); Jane White, Fishers, IN (US); Sek Chai, Valencia, CA (US)

Correspondence Address: Joseph S Tripoli, Thomson Multimedia Licensing, P O Box 5312, Princeton, NJ, 08540-5312, US

(21) Appl. No.: 10/221,962

(22) PCT Filed: Dec. 21, 2000
(86) PCT No.: PCT/US00/34676

(51) Int. Cl. G06F 17/60

(52) U.S. Cl. 705/14

(57) ABSTRACT

A system and method for manipulating Internet-based ads, wherein the ads are manipulated using a browser that detects such ads. The detected ads can be displayed, deleted, replaced with other ads, or saved to a memory device by the browser. The browser can either be pre-programmed with instructions as to how to manipulate detected ads, or the browser can contact a web site maintained by the manufacturer of the browser each time it detects an ad so as to determine how to manipulate the ad. The manufacturer can earn revenue by only allowing the browser to display ads for which the manufacturer has been compensated by an advertiser. The present invention also includes an interface feature for selectively or automatically capturing detected ads, wherein such ads are not displayed on the browser but are instead stored in a memory device according to user-defined criteria for viewing at a subsequent time.

### FIELD OF THE INVENTION

The present invention relates to Internet advertising (ads), and more particularly to a method for manipulating such ads.

### BACKGROUND OF THE INVENTION

Internet-based advertising is an important source of revenue both for the owners of web sites that display such ads, as well as for the advertisers who use such ads to sell their goods and/or services to persons displaying such web sites. Conventional systems exist which enable browsers used by persons viewing a web site to block such ads from appearing on their browser. However, no mechanism presently exists that enables Internet-based ads to be manipulated so that such ads can be selectively replaced with other ads, or so that a browser can selectively capture such ads so that they are not displayed on the browser, but are instead saved for viewing at a more convenient time. It is therefore an object of the present invention to provide such a mechanism.

### SUMMARY

A system and method for manipulating Internet-based advertising, wherein ads detected by a browser can either be: displayed; deleted; selectively replaced with other ads; or selectively captured so that the ads are removed from the web page and saved in a directory for viewing at a later, more convenient time. The aforementioned acts of displaying, deleting or replacing ads can be selectively performed as specified by the manufacturer of the browser. The aforementioned act of capturing and saving ads can be selectively performed by the person using the browser.

### BRIEF DESCRIPTION OF THE DRAWINGS

FIG. 1 shows a block diagram of an exemplary embodiment of a system for displaying the Internet and manipulating detected Internet-based ads according to the present invention.

FIG. 2 shows a block diagram of an exemplary embodiment of a system for capturing and saving ads for later viewing according to the present invention.

FIG. 3 shows a web page from the Alta Vista web site.

FIG. 4 shows the web page shown in FIG. 3 after the ad has been deleted according to the present invention.

FIG. 5 shows a menu for activating the capturing and saving ads according to the present invention.

FIG. 6 shows a window comprised of captured ads and a menu for manipulating such captured ads according to the present invention.

FIG. 7 shows four menus offering different options for saving captured ads according to the present invention.

FIG. 8 shows a window comprised of captured ads of a particular category and a menu for manipulating such captured ads according to the present invention.

### DETAILED DESCRIPTION OF THE INVENTION

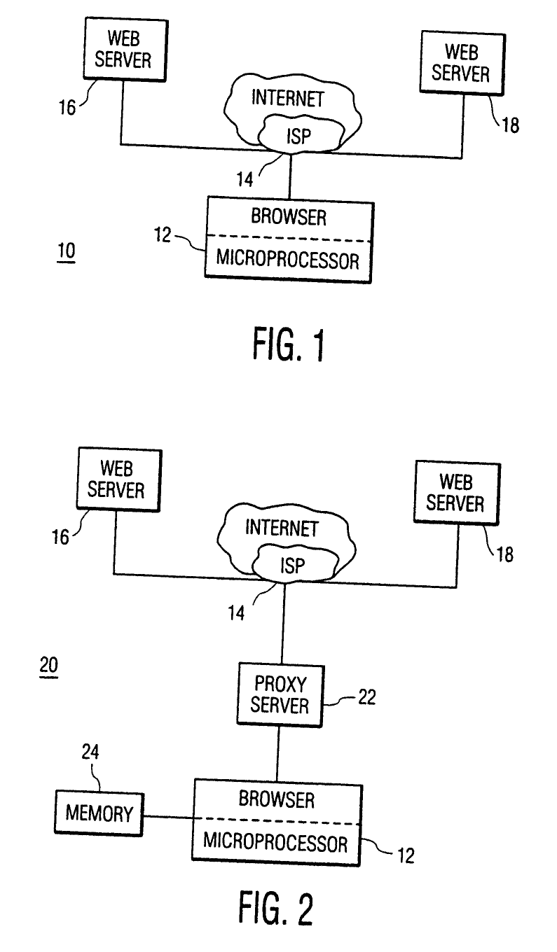

FIG. 1 shows a block diagram of an exemplary embodiment of a system 10 for manipulating Internet-based ads according to the present invention. System 10 is comprised of a browser 12 which is processed by a computer or the like. The system uses an Internet service provider (ISP) 14, such as America Online (AOL), to display web pages from a server 16 for a web site, such as AltaVista, and to display web pages from a server 18 for a web site maintained by the manufacturer of browser 12, e.g. Thomson. System 10 can be used irrespective of the type of connection, i.e., telephone line, cable line, digital subscriber line (DSL), satellite link, etc., that is used to establish a connection between browser 12 and servers 16 and 18. Exemplary embodiments of system 10 may include, but are not limited to a personal computer, a television, VRC or hard disk video replay device which has the capability of causing the display of a web page in accordance with the principles of the present invention.

Browser 12 detects the presence of ads on a web page using any one of numerous conventional techniques such as detecting an ad based on: the size an object occupies on a web page; the type of picture that appears on a web page; the location/placement of a picture on a web page; the presence of a certain object types, e.g., a “.gif” file, on a web page; the presence of animated graphics which are frequently used in on-line ads on the web page; or the presence of key words, such as “sponsor”, “ad”, etc., in the HTML code that specifies the configuration of a web page. Browser 12 can also detect ads using any combination of the foregoing techniques.

When browser 12 detects an internet-based ad, it displays the ad, deletes the ad, or replaces the detected ad with another ad. Such a feature can be used in several ways. For example, in one embodiment, this feature enables the manufacturer of browser 12, i.e., Thomson, to cause browser 12 to delete any ads it detects that appear for one of the manufacturer's competitors, e.g., Sony.

In another embodiment, browser 12 replaces ads that it detects for the manufacturer's competitors with ads for the manufacturer. In still another embodiment, the manufacturer can earn revenue by causing browser 12 to replace detected ads for companies that have not compensated, i.e., paid, the manufacturer with ads for companies that have compensated the manufacturer. In still yet another embodiment, the manufacturer can earn revenue by only enabling browser 12 to display ads and/or web pages for advertisers and/or web site operators, respectively, who have paid the manufacturer. Browser 12 can be fabricated to include any number of the foregoing embodiments.

The foregoing embodiments can be implemented in several different ways. For example, each browser 12 sold by the manufacturer can be sold pre-programmed with a series of ads for the manufacturer that would be used to replace any competitors' ads detected by browser 12. Browser 12 can also be sold pre-programmed with ads for paying advertisers that would be used to replace ads for non-paying advertisers detected by browser 12. The replacement ads for the manufacturer of browser 12 and for paying advertisers can be of varying size so that they can replace similarly sized ads. In addition, each browser 12 can be sold pre-programmed to include a list of authorized advertisers and/or web site operators that have compensated the manufacturer so that browser 12 can display detected ads and/or sites for such advertisers and/or operators.

In yet another alternative embodiment, browser 12 can be sold pre-programmed to detect URLs and/or pass codes in comment portions of HTML language that indicate that the web site operator or advertiser, respectively, has paid the manufacturer so that such sites and/or ads can be displayed and viewed using browser 12. The pre-programmed replacement ads, lists of authorized advertisers and/or web site operators, and list of pass codes, can be periodically updated by means of plug-ins that are sent by mail or electronically to each owner of a browser 12.

Instead of being sold pre-programmed with replacements ads, a list of authorized advertisers/web site operators, or a list of pass codes, browser 12 can be sold pre-programmed so that it periodically contacts server 18 to download replacement ads, and/or to verify which advertisers and/or web site operators have compensated the manufacturer so that browser 12 can display their ads and/or web sites.

The present invention can analyze the URL of a web page to verify whether the manufacturer has been paid by an advertiser and/or web site operator. Specifically, when browser 12 detects an ad, it can transmit the URL to the manufacturer's server 20 to determine if compensation has been paid. In response, server 20 will advise browser 12 whether compensation has been paid, and thus whether it can display the ad. In the same manner, the present invention can also verify whether the manufacturer has been compensated by having browser 12 transmit to server 20 the pass code of a detected ad/web page so that it can be can be compared with a list of pass codes indicating those advertisers and/or web site operators who have compensated the manufacturer. In response, server 20 will advise browser 12 whether compensation has been paid, and thus whether it can display the ad. The pass codes can be embedded in the comment portion of the HTML. When browser 12 communicates with server 20 it can send information regarding the size of a detected ad so that server 20 can send browser 20 a replacement ad that is the same size or nearly the same size as the detected ad.

The present invention also includes a feature, hereinafter referred to as AdCapture, that enables detected ads to be captured, wherein such ads are not displayed on the display device of browser 12 but are instead archived, i.e., stored according to user-defined criteria, such as the subject matter of the ad, the type of ad, the date the ad was captured, etc., for display on browser 12 at a later time. FIG. 2 shows a block diagram of an exemplary embodiment of an AdCapture system 20 according to the present invention, wherein system 10 is comprised of browser 12, ISP 14 and servers 16 and 18 shown in FIG. 1, and a proxy server 22 which is coupled between browser 12 and ISP 14 and captures detected ads. System 20 also includes an archive, i.e., memory device, 24 on which captured ads are stored according to the user-defined criteria. System 20 can be implemented with proxy browser 22 and memory 24 being fabricated as part of browser 12 rather than as separate, stand alone devices.

Proxy browser 22 screens all web pages and captures and stores such ads. By filtering ads so that they are not displayed on browser 12, proxy browser 22 enables users to both screen undesirable content as well as increase the speed at which browser 12 can be used to explore the Internet. The AdCapture feature also benefits users who because of time constraints do not have the time to click on ads and/or do not know if they will be able to return to a previously displayed screen if they click on an ad.

The AdCapture feature of the present invention is an interface that is activated and controlled using a combination of mouse and/or keyboard commands that cause on-screen windows and menus to be displayed over browser 12. The AdCapture feature can either be selectively activated by a user, or it can be activated so that all ads are automatically captured. Ads stored in memory 24 can be sorted and/or searched on the basis of the user-defined criteria. Stored ads retain any links they may have to web sites so that such links can be utilized to access the linked sites when the stored ads are retrieved for display on browser 12. Also, the AdCapture feature can prompt a user to view stored ads on a predetermined periodic basis. Failure to view such ads by the time such period expires can result in either the ads being deleted from memory 24 or the AdCapture feature being disabled until the captured ads are viewed.

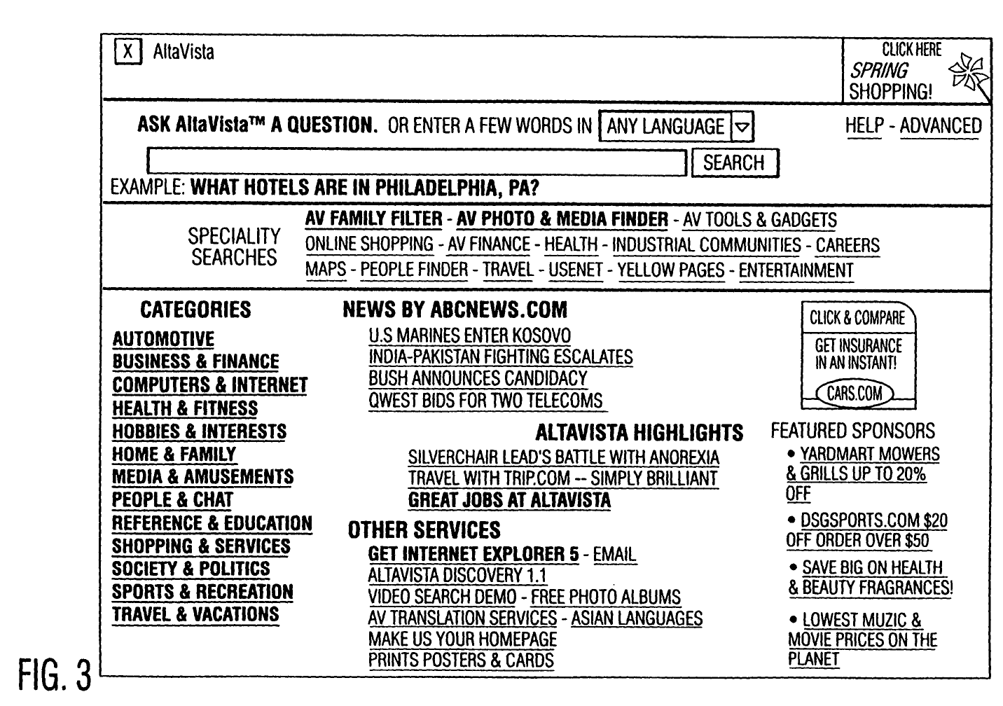

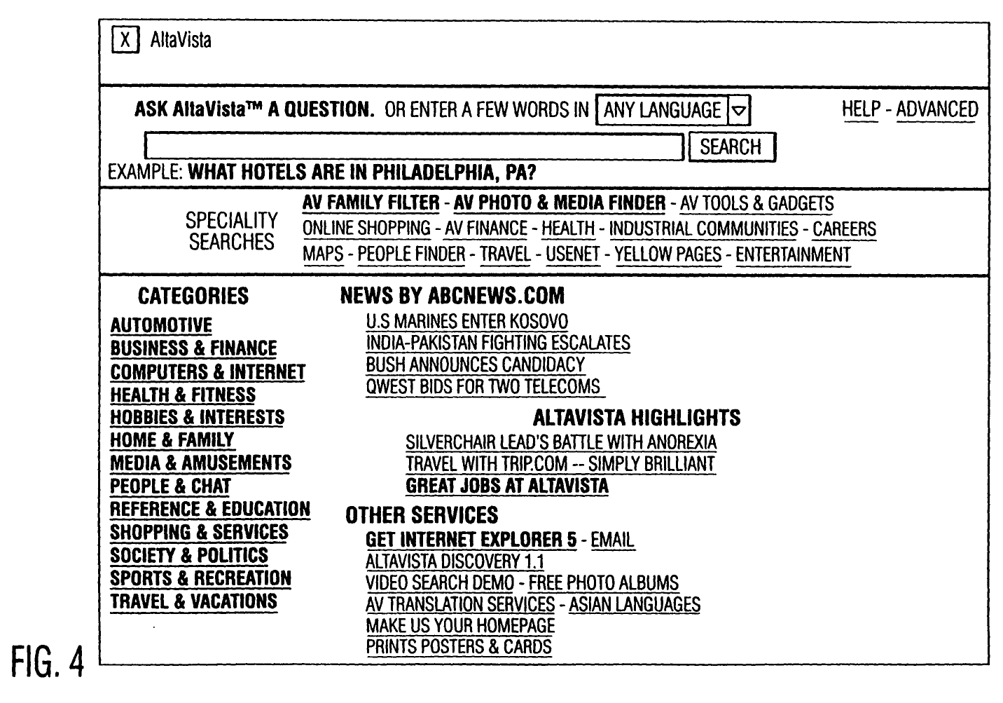

When the AdCapture feature is turned on, detected ads are diverted to memory 24 and the space that the ad would have occupied on the display device of browser 12 is instead filled with a non-invasive, subdued background and a small AdCapture signature. The background can be stretched or shrunk to fit any ad window. When the user wants to review the stored ads, the user uses the control features to cause a window to be displayed for such purpose. Detected ads received from server 16 which are to be captured using the present invention are stripped from the received HTML code and stored in memory 24. FIG. 3 shows a web page from the Alta Vista web site. FIG. 4 shows the web page shown in FIG. 3 after the ad has been deleted according to the present invention.

Ads displayed on web sites are typically tagged by such sites with text attributes that can be used by system 20 to automatically categorize any such ads that are captured. When a detected ad is captured using the AdCapture feature, system 20 can use such attributes to replace the ad with textual information or an icon in the non-invasive background on browser 12, which text or icon indicates the type of ad captured, the subject matter of the captured ad, or the identity of the advertiser of the captured ad.

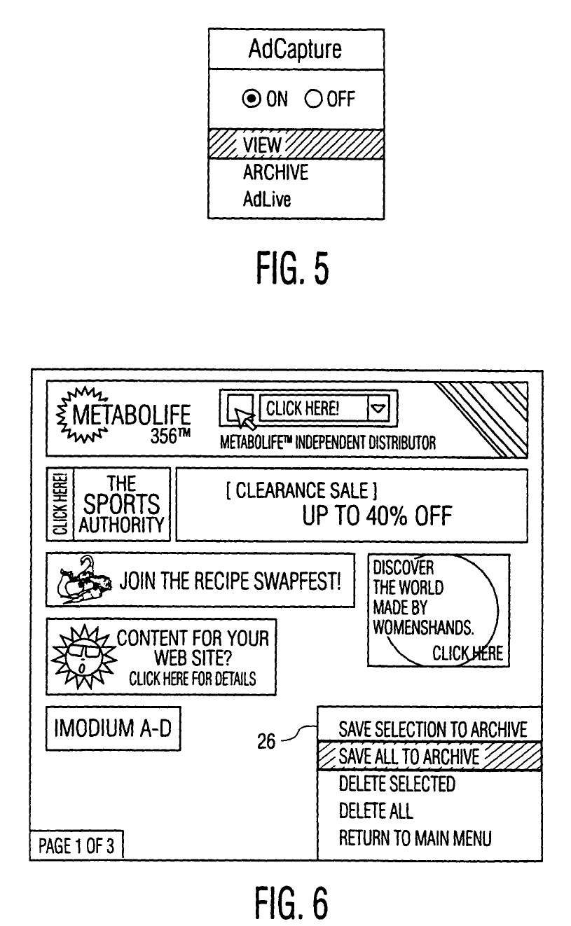

FIG. 5 shows a menu which allows a user to turn the AdCapture feature on or off. If the feature is turned on, the user is given the option of either viewing the ad or saving the ad in memory 24.

FIG. 6 shows a window comprised of a plurality of captured ads and a menu 26, wherein a single captured ad or all of the captured ads shown can be saved in memory 24 or deleted. Alternatively, a user can return to the main menu shown in FIG. 5 from this window.

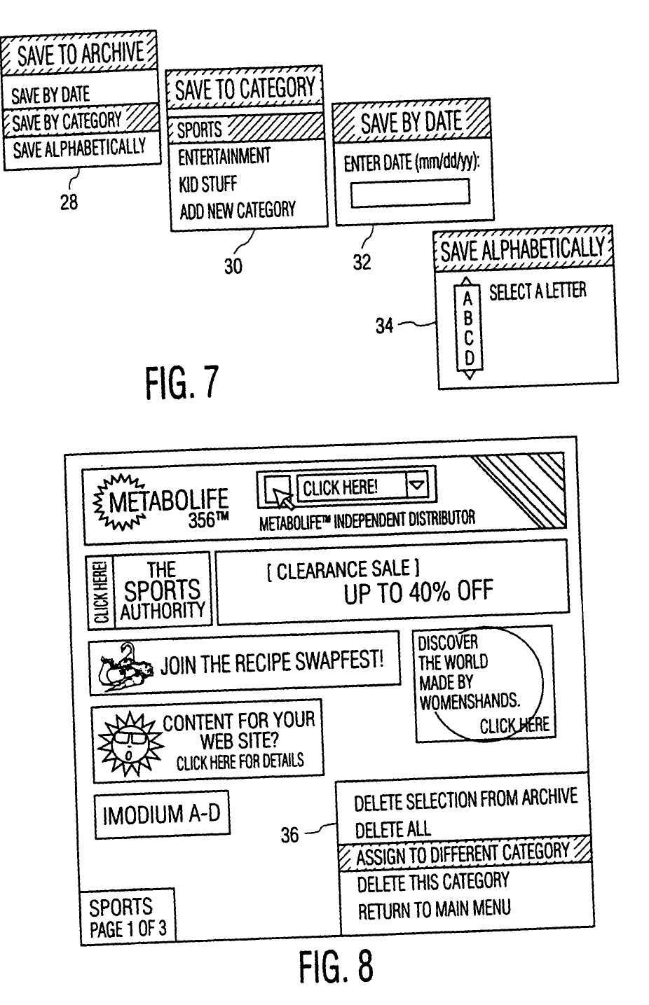

FIG. 7 shows a plurality of menus indicating different criteria by which captured ads can be stored and otherwise manipulated according to the present invention. A “Save to Archive” menu 28 offers a user the option of saving an ad by date, category or alphabetically. If, as shown, the highlighted “Save to Category” feature is selected in menu 28, a menu 30 appears in which several categories are presented to a user. Menu 30 also enables a user to create any number of categories. If the “Save by Date” feature is selected in menu 28, a window 32 appears that enables the user to enter the date. If the “Save Alphabetically” feature is selected in menu 28, a window 34 appears that enables a user to save a viewed ad alphabetically.

FIG. 8 shows a window comprised of a plurality of ads in a particular category, i.e., sports, and a menu 36, wherein either a single captured ad or all of the captured ads shown can be saved in memory 24, deleted, or assigned to a different category. Alternatively, a user can return to menu 28 from this window.

The present invention is implemented using software which can be written in any programming language. The present invention is also implemented using hardware such as a microcontroller, a microcomputer, or a microprocessor. The present invention can be used on a global or local computer network, on a personal computer, with viewable storage media such as a CD ROM, on a wireless telephone, on a wireless personal assistant such as a Palm Pilot®, or on any type of wired or wireless device that enables digitally stored information to be viewed on a display device. Also, information displayed and viewed using the present invention can be printed, stored to other storage medium, and electronically mailed to third parties.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiments may be varied without departing from the spirit of the invention, and the exclusive use of all modifications which come within the scope of the appended claims is reserved.

1. A system for manipulating Internet-based ads, comprising:
means for detecting an ad on a web site and for determining whether to display a detected ad on a display device or to replace the detected ad with another ad to be displayed on the display device; and
means for displaying one of the detected ad and the replaced ad.

2. The system according to claim 1, wherein the means for displaying is a browser.

3. The system according to claim 2, wherein the detected ad is displayed if an advertiser responsible for such ad has compensated a manufacturer of the browser.

4. The system according to claim 2, wherein the detected ad is replaced with another ad if an advertiser responsible for such ad has not paid a manufacturer of the browser.

5. The system according to claim 2, wherein the browser uses software pre-programmed on the browser to determine whether an advertiser has paid a manufacturer of the browser.

6. The method according to claim 2, wherein the browser contacts a web site maintained by a manufacturer of the browser to determine whether an advertiser has paid the manufacturer.

7. The system according to claim 2, wherein the browser does not display the detected ad until after first determining that an advertiser has paid a manufacturer of the browser.

8. The method according to claim 2, wherein the browser is sold preprogrammed with at least one replacement ad.

9. The system according to claim 2, wherein the browser downloads at least one replacement ad from a web site maintained by a manufacturer of the browser.

10. The system according to claim 2, wherein the browser replaces a detected ad with an ad for a manufacturer of the browser.

11. The system according to claim 2, wherein the browser replaces a detected ad for a non-paying advertiser with an ad for an advertiser who has paid a manufacturer of the browser.

12. The system according to claim 2, wherein the browser determines whether an advertiser has paid a manufacturer of the browser by analyzing a URL or a pass code in a comment portion of an HTML line of code.

13. The system according to claim 1, wherein the system selectively captures the detected ad so that the ad is prevented from being displayed on the display device and is saved to a memory device for display at a subsequent time.

14. The system according to claim 13, wherein the captured ad is stored according to user-defined criteria.

15. The system according to claim 14, wherein a user can search, view, delete and otherwise manipulate the stored ad by the user-defined criteria.

16. The system according to claim 13, wherein the detected ad is automatically captured and stored by the browser.

17. The system according to claim 13, wherein if the stored ad is not viewed within a predetermined period of time, the ad is deleted from the memory device.

18. The system according to claim 13, wherein if the stored ad is not viewed within a predetermined period of time, the ability to capture and store ads is disabled.

19. A method for manipulating Internet-based ads, comprising the steps of:
detecting an ad on a web site; and
determining whether to display a detected ad on a display device or replace the detected ad with another ad to be displayed on the display device.

20. The method according to claim 19, wherein the ad is detected using a browser.

21. The method according to claim 20, wherein the detected ad is displayed if an advertiser responsible for such ad has compensated a manufacturer of the browser.

22. The method according to claim 20, wherein the detected ad is replaced with another ad if an advertiser responsible for such ad has not paid a manufacturer of the browser.

23. The method according to claim 20, wherein the browser uses software pre-programmed on the browser to determine whether an advertiser has paid a manufacturer of the browser.

24. The method according to claim 20, wherein the browser contacts a web site maintained by a manufacturer of the browser to determine whether an advertiser has paid the manufacturer.

25. The method according to claim 20, wherein the browser replaces a detected ad for a non-paying advertiser with an ad for an advertiser who has paid a manufacturer of the browser.

26. The method according to claim 20, wherein the browser determines whether an advertiser has paid a manufacturer of the browser by analyzing a URL or a pass code in a comment portion of an HTML line of code.

27. The method according to claim 19, further comprising the step of selectively capturing the detected ad so that the ad is prevented from being displayed on the display device and is saved to a memory device for display at a subsequent time.

28. The method according to claim 27,. wherein the captured ad is stored according to user-defined criteria.
